(19) United States
(12) Patent Application Publication
(10) Pub. No.: US 2014/0006829 A1
(43) Pub. Date: Jan. 2, 2014

(54) REVERSE-PROXYING METHOD AND SERVER/CLIENT SYSTEM USING THE SAME

(71) Applicants: Sang Hak Lee, Seongnam-si (KR); Jung Mee Yun, Seoul (KR)

(72) Inventors: Sang Hak Lee, Seongnam-si (KR); Jung Mee Yun, Seoul (KR)

(73) Assignee: KOREAN ELECTRONICS TECHNOLOGY INSTITUTE, Seongnam-si, Gyeonggi-do (KR)

(21) Appl. No.: 14/004,071

(22) PCT Filed: Dec. 28, 2011
(86) PCT No.: PCT/KR11/10219

§ 371 Date: Sep. 9, 2013

(30) Foreign Application Priority Data
Mar. 10, 2011 (KR) 10-2011-0021290

(51) Int. Cl. G06F 1/32

(52) U.S. Cl. CPC G06F 1/3234
USPC 713/323

(57) ABSTRACT

A reverse-proxying method and a server/client system using the same are provided. The reverse-proxying method includes: providing, by a server, a service to a client; and, when the server enters a standby mode, providing, by a reverse-proxying server connected to the server, some services of the server on behalf of the server. Accordingly, the client receives the service without interruption and energy efficiency of the whole system is improved.

### CROSS-REFERENCE TO RELATED APPLICATION

This application claims priority from Korean Patent Application No. 10-2011-0021290, filed on Mar. 10, 2011 in the Korean Intellectual Property Office, the disclosure of which is incorporated herein by reference in its entirety.

### BACKGROUND

1. Field

Methods and apparatuses consistent with exemplary embodiments relate to a client/server system, and more particularly, to a method for managing a system to reduce power consumption in a server/client system.

2. Description of the Related Art

FIG. 1 is a view illustrating a configuration of a related-art server/client system. As shown in FIG. 1, the server/client system is established by a plurality of clients 11 to 14 which request services and a plurality of servers 21 to 23 which provide services. In the server/client system, the clients and the servers are connected with each other to communicate with each other through the Internet.

When the server/client system of FIG. 1 is established in an enterprise, the servers 21 to 23 should run in an on mode to always provide services. Such a server/client system is beneficial to stability and regular operability of the services, but is inefficient in terms of energy efficiency because it always consumes the maximum power regardless of whether the service is provided or not.

According to statistics, the service is intensively provided in a specific time zone and is intermittently provided in the other time zones. Therefore, the servers 21 to 23 which maintain the on mode when providing the service intermittently are more inefficient in terms of energy efficiency. Thus, there is a demand for a method for improving a server/client system.

### SUMMARY

One or more exemplary embodiments may overcome the above disadvantages and other disadvantages not described above. However, it is understood that one or more exemplary embodiment are not required to overcome the disadvantages described above, and may not overcome any of the problems described above.

One or more exemplary embodiments provide a reverse-proxying method by which a reverse-proxying server provides some services, which have been provided by a server, on behalf of the server when the server, which normally provides a service to a client, enters a standby mode, and a system using the same.

According to an aspect of an exemplary embodiment, there is provided a reverse-proxying method including: providing, by a server, a service to a client, and, when the server enters a standby mode, providing, by a reverse-proxying server connected to the server, some services of the server on behalf of the server.

The providing the services on behalf of the server may include, when the reverse-proxying server is able to provide a service requested by the client on behalf of the server, providing, by the reverse-proxying server, the service requested by the client to the client.

The providing the services on behalf of the server may include: when the reverse-proxying server is not able to provide the service requested by the client on behalf of the server, requesting, by the reverse-proxying server, the server to wake up, and providing, by the server which wakes up according to the wakeup request from the reverse-proxying server, the service requested by the client to the client.

The reverse-proxying method may further include, when the server wakes up, stopping, by the reverse-proxying server, providing some services of the server on behalf of the server.

The server may enter the standby mode when there is no request from the client for a predetermined time.

The some services may be services of high frequency from among services requested by the client.

The reverse-proxying method may further include obtaining and storing, by the reverse-proxying server, contents of some services of the server.

According to an aspect of another exemplary embodiment, there is provided a server system including: a server configured to provide a service to a client; and a reverse-proxying server connected to the server and configured to provide some services of the server on behalf of the server when the server enters a standby mode.

According to exemplary embodiments as described above, the server normally provides a service to the client, and, the reverse-proxying server, which operates by low power, provides some of the services of the server on behalf of the server when the server enters the standby mode. Therefore, power consumed in the whole system can be reduced and thus energy efficiency of the whole system can be improved.

In particular, power use efficiency can be improved when the services of the system are not used frequently in a network of an enterprise, such as in the nighttime or at the weekend. Also, even when the server enters the standby mode, there is no problem in that the client receives a desired service without interruption.

### BRIEF DESCRIPTION OF THE DRAWING FIGURES

The above and/or other aspects will be more apparent by describing in detail exemplary embodiments, with reference to the accompanying drawings, in which:

FIG. 1 is a view illustrating a configuration of a related-art server/client system;

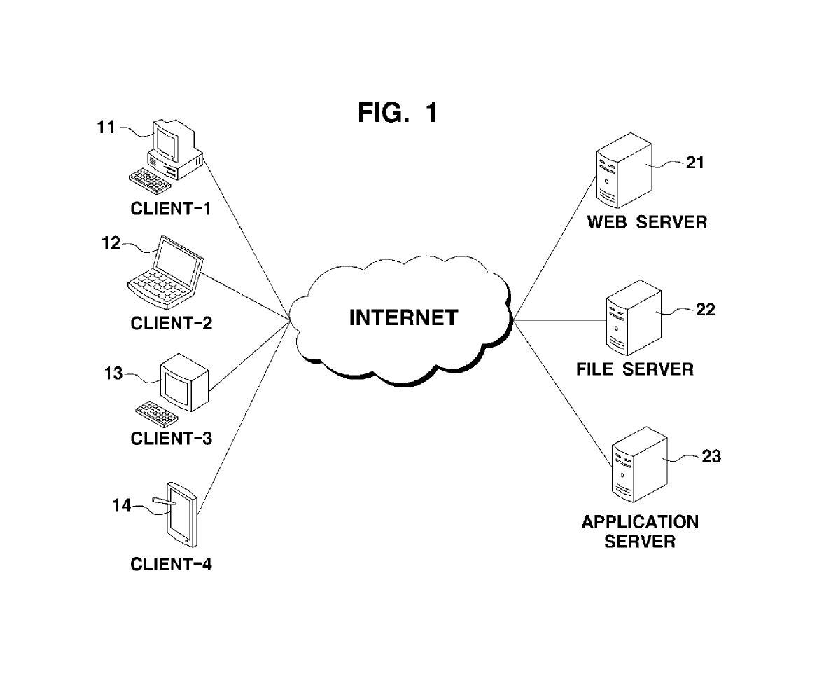

FIG. 2 is a view illustrating a server/client system according to an exemplary embodiment;

FIG. 3 is a view to explain a reverse-proxying method according to an exemplary embodiment; and

FIG. 4 is a detailed block diagram of a reverse-proxying server of FIG. 2.

### DETAILED DESCRIPTION OF EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of exemplary embodiments. Thus, it is apparent that exemplary embodiments can be carried out without those specifically defined matters. Also, functions or elements known in the related art are not described in detail since they would obscure the exemplary embodiments with unnecessary detail.

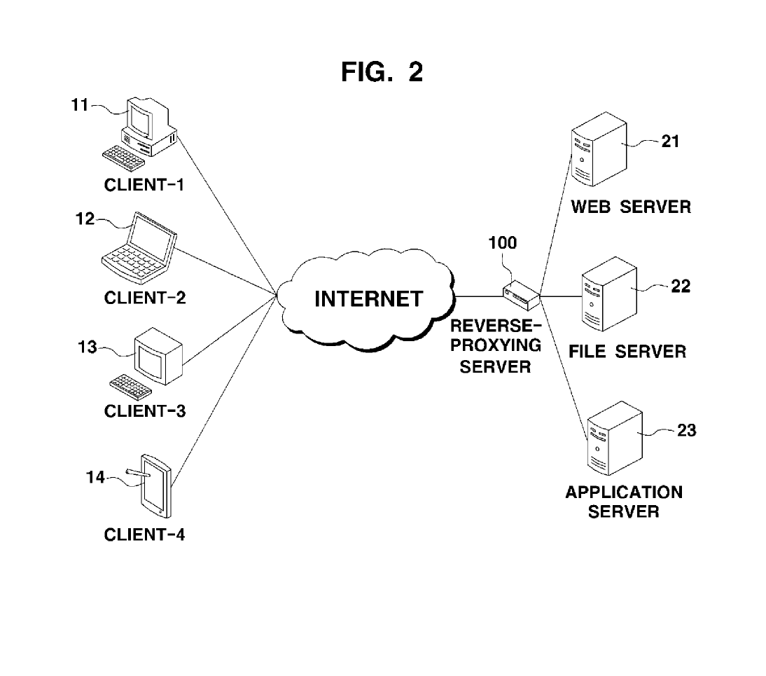

FIG. 2 is a view illustrating a server/client system according to an exemplary embodiment. As shown in FIG. 2, the server/client system according to an exemplary embodiment includes clients 11 to 14, servers 21 to 23, and a reverse-proxying server 100, which are connected with one another to communicate with one another, and may manage a network in a reverse-proxying technique.

The clients 11 to 14 are terminal devices that request services from the servers 21 to 23 through the Internet, and specifically, request necessary web pages, files, and applications.

The web server 21 is a server that runs/manages a web site, and provides web pages which are requested by the clients 11 to 14 to the clients 11 to 14.

The file server 22 is a server that stores a plurality of files constituting a database, and stores files that are requested to be stored by the clients 11 to 14 and also provide files that are requested by the clients 11 to 14 to the clients 11 to 14.

The application server 23 performs transaction processing (TP) and managing in a client/server environment, and performs application interlocking between different kinds of systems.

The reverse-proxying server 100 provides the services of the servers 21 to 23 on behalf of the servers. The reverse-proxying server 100 does not always provide the services on behalf of the servers and provides the services on behalf of the servers only in a “special situation”. The special situation recited herein refers to a situation in which the servers 21 to 23 enter a standby mode.

The servers 21 to 23 may enter the standby mode when they do not receive a service request from the clients 11 to 14 for a predetermined time (for example, “10 minutes”).

The servers 21 to 23 may enter the standby mode separately. For example, the web server 21 and the file server 22 may not receive a service request from the clients 11 to 14 for a predetermined time and thus may enter the standby mode, but the application server 23 may receive a service request from the clients 11 to 14 and thus may not enter the standby mode.

The reverse-proxying sever 100 does not provide all of the services of the servers 21 to 23 on behalf of the servers, and provides only “some” of the services on behalf of the servers.

Specifically, the reverse-proxying server 100 may provide 1) some of the services provided by the web server 21 (for example, some of the web pages provided by the web server 21), 2) some of the services provided by the file server 22 (for example, some of the files provided by the file server 22), and some of the services provided by the application server 23 (for example, only an internet telephone service from among the services provided by the application server 23), on behalf of the servers.

Since the reverse-proxying server 100 provides fewer services than the general servers 21 to 23, the reverse-proxying server 100 may be implemented by using a server which has a low processing ability and a small storage space. Accordingly, the reverse-proxying server 100 consumes less power than the general servers 21 to 23.

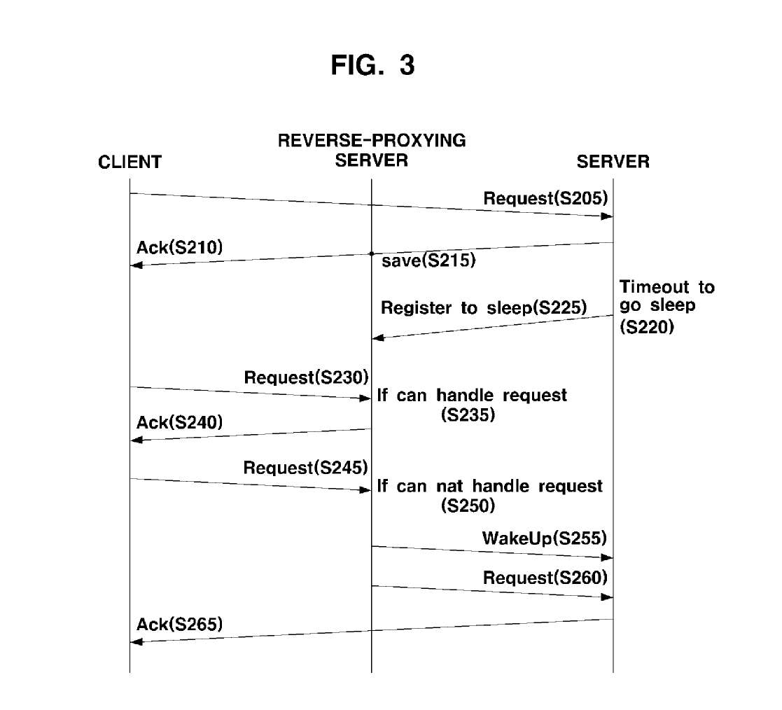

Hereinafter, a process of performing reverse-proxying in the server/client system of FIG. 2 will be explained with reference to FIG. 3. FIG. 3 is a view to explain a reverse-proxying method according to an exemplary embodiment.

In FIG. 3, the number of clients and the number of servers are set to 1. However, this is just for convenience of explanation and the reverse-proxying method, which will be explained below, may be applied when a plurality of clients or a plurality of servers are provided or when a plurality of clients and a plurality of servers are provided.

As shown in FIG. 3, when there is a service request from the client (S205), the server provides the service that is requested by the client in operation S205 (S210). The server is running in an on-mode.

While the service is request/provided, the reverse-proxying server stores contents of the service which is transmitted from the server to the client in operation S210 (S215).

For example, when the service provided from the server to the client in operation S210 is a web page, the reverse-proxying server copies the web page which is transmitted from the server to the client and stores the web page. For another example, when the service provided from the server to the client in operation S210 is a file, the reverse-proxying server copies the file which is transmitted from the server to the client and stores the file in operation S215.

When the reverse-proxying server is not able to store a new web page or file due to its limited storage space, the reverse-proxying server may delete a web page or file that has been less frequently requested by the client, and may store the new web page or file.

Alternatively, when the reverse-proxying server is not able to store a new web page or file, the reverse-proxying server may delete a web page or file that was requested first by the client (that is, the earliest provided web page or file), and may store the new web page or file.

When there is no service request from the client for a predetermined time (S220), the server enters a standby mode and notifies the reverse-proxying server of this (S225).

When the reverse-proxying server receives a notification indicating that the server enters the standby mode, the reverse-proxying server enters a server proxy mode. When the reverse-proxying server enters the server proxy mode, the reverse-proxying server receives a request of the client on behalf of the server and provides some of the services that may be provided by the server on behalf of the server.

Some services that are provided by the reverse-proxying server on behalf of the server are the services that are stored in operation S215. Accordingly, since the service that is not stored in operation S215 from among the services provided by the server cannot be provided by the reverse-proxying server on behalf of the server, the reverse-proxying server requests the service from the server. Hereinafter, a detailed process will be explained with reference to FIG. 3.

As shown in FIG. 3, the client requests a service (S230). When the reverse-proxying server is able to provide the service on behalf of the server (S235), the reverse-proxying server provides the service which is requested by the client to the client (S240).

However, when the client requests a service (S245) but the reverse-proxying server is not able to provide the service on behalf of the server (S250), the reverse-proxying server requests the server to wake up (S255) and transmits the client's service request to the server (S260).

The server which enters the on-mode in response to the wake-up request from the reverse-proxying server in operation S255 directly provides the service corresponding to the request transmitted in operation S260 to the client (S265).

When the server wakes up, the reverse-proxying server changes the server proxy mode to the standby mode and stops providing the service on behalf of the server. This is because the server in the on-mode will directly provide the services requested by the client to the client.

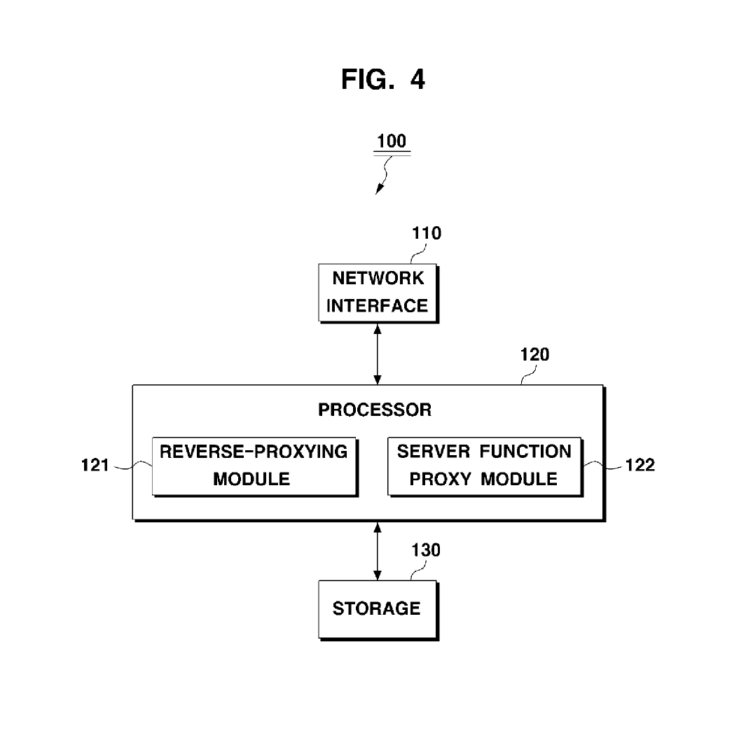

Hereinafter, an internal configuration of the reverse-proxying server 100 of FIG. 2 will be explained in detail with reference to FIG. 4. FIG. 4 is a detailed block diagram of the reverse-proxying server 100 of FIG. 2.

As shown in FIG. 4, the reverse-proxying server 100 includes a network interface 110, a processor 120, and a storage 130.

The network interface 110 is an interface for communicating with the server and the client.

The processor 120 performs main operations that should be performed by the reverse-proxying server 100 from among the operations shown in FIG. 3, and includes a reverse-proxying module 121 and a server function proxy module 122.

The server function proxy module 122 is a module for providing a service requested by the client on behalf of the server. When the reverse-proxying server 100 receives a notification indicating that the server enters the standby mode from the server, the reverse-proxying module 121 receives a request from the client and transmits the request to the server function proxy module 122. When it is determined that the server function proxy module 122 is not able to provide the service on behalf of the server, the reverse-proxying module 121 requests the server to wake up through the network interface 110, and transmits the client's request to the server.

The storage 130 is a storage space in which the services provided from the server to the client are stored.

The reverse-proxying method of the reverse-proxying server 100 and the server/client system performing the same according to exemplary embodiments have been explained so far. Although one reverse-proxying server 100 provides services on behalf of one or a plurality of servers in the above-described exemplary embodiments, this is merely an example for convenience of explanation.

A plurality of reverse-proxying servers may be provided and one of the plurality of reverse-proxying servers may provide services on behalf of only some of the servers existing in the system.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A reverse-proxying method comprising:
providing, by a server, a service to a client; and
when the server enters a standby mode, providing, by a reverse-proxying server connected to the server, some services of the server on behalf of the server.

2. The reverse-proxying method as claimed in claim 1, wherein the providing the services on behalf of the server comprises, when the reverse-proxying server is able to provide a service requested by the client on behalf of the server, providing, by the reverse-proxying server, the service requested by the client to the client.

3. The reverse-proxying method as claimed in claim 2, wherein the providing the services on behalf of the server comprises:
when the reverse-proxying server is not able to provide the service requested by the client on behalf of the server, requesting, by the reverse-proxying server, the server to wake up; and
providing, by the server which wakes up according to the wakeup request from the reverse-proxying server, the service requested by the client to the client.

4. The reverse-proxying method as claimed in claim 1, further comprising, when the server wakes up, stopping, by the reverse-proxying server, providing some services of the server on behalf of the server.

5. The reverse-proxying method as claimed in claim 1, wherein the server enters the standby mode when there is no request from the client for a predetermined time.

6. The reverse-proxying method as claimed in claim 1, wherein the some services are services of high frequency from among services requested by the client.

7. The reverse-proxying method as claimed in claim 1, further comprising obtaining and storing, by the reverse-proxying server, contents of some services of the server.

8. A server system comprising:
a server configured to provide a service to a client; and
a reverse-proxying server connected to the server and configured to provide some services of the server on behalf of the server when the server enters a standby mode.
